(19) United States
(12) Patent Application Publication
(10) Pub. No.: US 2024/0402045 A1
(43) Pub. Date: Dec. 5, 2024

(54) SYSTEM FOR MONITORING A ROLLING BEARING AND ASSOCIATED METHOD

(71) Applicant: AKTIEBOLAGET SKF, GOTEBORG (SE)

(72) Inventors: Stephan BAGGEROHR, Houten (NL); Andreas Clemens VAN DER HAM, Warnsveld (NL); Dominik FRITZ, Würzburg (DE); Matthias HAPP, Schweinfurt (DE); Jesko-Henning TANKE, Schweinfurt (DE); Defeng LANG, Delft (NL); Juergen REICHERT, Donnersdorf (DE)

(21) Appl. No.: 18/668,686

(22) Filed: May 20, 2024

(30) Foreign Application Priority Data
Jun. 2, 2023 (DE) 102023205167.2

(51) Int. Cl. G01M 13/045; F16C 19/52

(52) U.S. Cl. CPC G01M 13/045; F16C 19/522; F16C 19/527; F16C 2233/00

(57) ABSTRACT

A method for monitoring a rolling bearing that has a sensorized rolling element includes sampling acceleration signals and load signals from the sensorized rolling element to produce acceleration values and load values each associated with a time instant, determining a rotation speed of the rotatable ring, determining a phase function of the sensorized rolling element from the acceleration values and the rotation speed of the rotatable ring, processing the load values to determine a magnitude of a resulting signal representative of a frequency content of an envelope of the load values over time, and detecting a damage of the rolling bearing and a location of the damage on the rolling bearing from the magnitude of the resulting signal and the phase function.

### CROSS-REFERENCE

This application claims priority to German patent application no. 10 2023 205 167.2 filed on Jun. 2, 2023, the contents of which are fully incorporated herein by reference.

### TECHNOLOGICAL FIELD

The present disclosure is directed to a method and system for monitoring a rolling bearing in a machine. More particularly, the disclosure is directed to monitoring a rolling bearing using a sensorized rolling element.

### BACKGROUND

Generally, a bearing is monitored to detect bearing damage. The document US 2018/003492 discloses a sensorized roller comprising a measuring device. The measuring device comprises sensors, for example a load sensor, an accelerometer, and a gyroscope to monitor for example the raceways of the bearing on which the sensorized roller is rolling. The measurements of the sensors are wirelessly transmitting to an external receiver.

An embedded data collection system in the sensorized roller, comprising the sensors, has a limited recording window so that a limited amount of data points are collected. Depending on the speed of the shaft as well as the sampling rate set, the data collected may not mirror a full pass around the bearing in one recording session.

One solution is to make multiple recordings of the raceway. However, multiple recording requires an accurate prediction of the sensor roller location to line up the data from different recording sessions. However, the sensorized roller has a measuring direction so that the path traced by the sensorized roller around the raceway as it spins is not unique. At two different time stamps the sensorized roller may be at two different orientations by the time it reaches the exact same point on the raceway.

### SUMMARY

Consequently, one aspect of the present disclosure is to line up data from different recording sessions recorded by the sensorized roller. Another aspect of the disclosure is a method for monitoring a rolling bearing in a machine.

The rolling bearing comprises a stationary ring and a movable ring configured to rotate concentrically relative to one another, and at least one row of rolling elements interposed between a first raceway and a second raceway respectively provided on the first and second rings. At least one of the rolling elements is a sensorized rolling element comprising at least one accelerometer for measuring an acceleration of the sensorized rolling element and at least one load sensor measuring a load applied on the sensorized rolling element.

The method includes: sampling signals delivered by accelerometer and load sensor to deliver at least a first set of acceleration values and load values, each value of the first set being associated to a sampling instant, the number of values being predetermined; determining the rotation speed of the rotatable ring; transmitting by the sensorized rolling element the first set of acceleration and load values; determining a phase function of the sensorized rolling element from the acceleration values and the rotation speed of the rotatable ring; processing the load values of the first set to determine the magnitude of a resulting signal representative of the frequency content of the envelope of the load values of the first set over time; and detecting a damage of the rolling bearing and locating the damage on the bearing from the magnitude of the resulting signal and the phase function.

The presented method allows the data generated by sensors of the rolling bearing during different recording sessions of the sensorized roller element to be aligned in order to detect and locate damages on the rolling bearing.

Preferably, the sensorized rolling element further comprises a gyroscope, the rotation speed of the rotatable ring being determined from measurement delivered by the gyroscope.

Advantageously, determining the phase function comprises: converting the acceleration values of the first set associated to sampling instants to acceleration values of the first set associated to angular positions of the rotatable ring; fitting a sinusoidal function on the acceleration values of the first set to link each acceleration value of the first set to an angular position of the rotatable ring up to a tolerance value; and estimating the frequency and the phase shift of the sinusoidal function fitting the acceleration samples up to the tolerance value, the phase function P(t) being equal to:

$$P ( t ) = ( t - T 0 ) / T - [ ( t - T 0 ) / T ]$$

where F is the frequency, Φ is the phase, T0=−Φ/F, and T is the period of the acceleration samples of the first set.

Preferably, processing the load values of the first set includes: filtering the load values of the first set to remove the fundamental frequency of the load values; determining an envelope signal of the filtered load values; and performing a first spectral analysis of the envelope signal of the filtered set to obtain the resulting signal; wherein the magnitude of the resulting signal is equal to the root mean square of the resulting signal.

Advantageously, the method includes filtering the envelope signal before performing the first spectral analysis of the envelope signal to reduce the sidelobes in the frequency domain.

Preferably, determining an envelope of the filtered load values comprises performing a Hilbert transform of the filtered load values to obtain an analytical representation of the filtered load values, the envelope being the magnitude of the analytical representation.

Advantageously, performing a first spectral analysis comprises performing a continuous wavelet transform of the envelope signal. Preferably the continuous wavelet transform is a Morlet wavelet transform.

Advantageously, detecting a damage of the rolling bearing and locating the damage on the bearing includes: comparing the magnitude of the resulting signal to a predetermined detection threshold, and when the magnitude of the resulting signal is above the predetermined detection threshold a damage is detected, determining the location of the damage on the bearing from the instant and the duration of the magnitude of the resulting signal exceeding the detection threshold and the phase function.

According to another aspect, a monitoring system comprising a rolling bearing is disclosed.

The rolling bearing comprises a stationary ring and a rotatable ring capable of rotating concentrically relative to one another and at least one row of rolling elements interposed between a first raceway and a second raceway respectively provided on the first and second rings.

At least one of the rolling elements of the rolling bearing is a sensorized rolling element comprising at least one accelerometer for measuring an acceleration of the sensorized rolling element and at least one load sensor for measuring a load applied on the sensorized rolling element, and a sampler to sample signals delivered by the accelerometer and the load sensor.

The system includes: first determining means configured to determine the rotation speed of the rotatable ring; receiving means configured to receive at least a first set of acceleration values and load values determined by the sampler, each value of the first set being associated to a sampling instant, the number of values being predetermined; second determining means configured to determine a phase function of the sensorized rolling element from the acceleration values and the rotation speed of the rotatable ring; processing means configured to process the load values of the first set to determine the magnitude of a resulting signal representative of the frequency content of the envelope signal of the load values of the first set over time; and detecting means configured to detect a damage of the rolling bearing and locating the damage on the bearing from the magnitude of the resulting signal and the phase function.

### BRIEF DESCRIPTION OF THE DRAWINGS

Other advantages and features of the invention will appear on examination of the detailed description of embodiments, in no way restrictive, and the appended drawings in which:

FIG. 1 is a sectional view schematically illustrating a machine according to an embodiment of the present disclosure.

FIG. 2 is an exploded perspective view of a sensorized rolling element according to an embodiment of the present disclosure.

FIG. 3 is a flow chart illustrating a method for monitoring a rolling bearing according to an embodiment of the present disclosure.

FIG. 4 is a graph relating acceleration to phase angles of a sensorized rolling element according to an embodiment of the present disclosure.

FIG. 5 is a graph fitting the acceleration values according to an embodiment of the present disclosure.

FIG. 6 is a graph of load values delivered by the sensorized rolling element over time.

FIG. 7 is a graph of an envelope signal of the load values over the time.

FIG. 8 is a graph showing the filtered envelope signal of the load values over the time.

FIG. 9 is a graph showing an example of the magnitude of a resulting signal over the time.

FIG. 10 is a graph showing an example of a binary signal according to an embodiment of the present disclosure.

FIG. 11 is a graphical representation of damage detected.

FIG. 12 is a schematic representation of a processing module according to an embodiment of the present disclosure.

### DETAILED DESCRIPTION

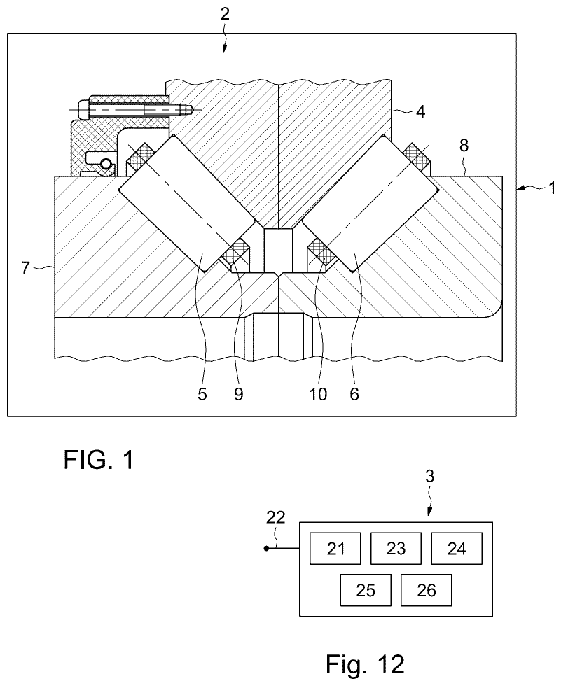

Reference is made to FIG. 1 which represents an example of a machine 1 comprising a rolling bearing 2, and a processing module 3, shown in FIG. 12. The machine 1 may be a wind turbine, and the rolling bearing 2 may be configured to support a main shaft of the wind turbine. In other embodiments, the machine may be a tunnel boring machine, a mining extraction machine or a big offshore crane.

The bearing 2 comprises a stationary ring 4 having conically shaped first and second outer raceways for a first row 5 and a second row 6 of rolling elements comprising tapered rollers. The bearing further comprises a rotatable ring provided with first and second inner rings 7, 8 axially stacked and which are respectively provided with conically shaped first and second inner raceways for the first and second roller rows 5, 6. In addition, the bearing 2 further comprises a first cage 9 and a second cage 10 for retaining the rollers of the first and second roller sets respectively. Typically, the cages 9, 10 are formed from segments that abut each other in the circumferential direction.

To provide the necessary stiffness and ensure a long service life, the bearing is preloaded. The axial position of the rotatable rings 7, 8 relatives to the stationary ring 4 is set such that the first and second roller sets 4, 6 have a negative internal clearance.

In the depicted bearing, at least one of the rolling elements in either of the first and second roller rows 5, 6 is replaced with a sensorized rolling element.

The rolling bearing 2 comprises tapered rollers. In another embodiment, the rolling bearing 2 may comprise other type of rolling elements, for example balls. The rolling bearing 2 may also comprise only one row of rolling elements or more than two rows of rolling elements.

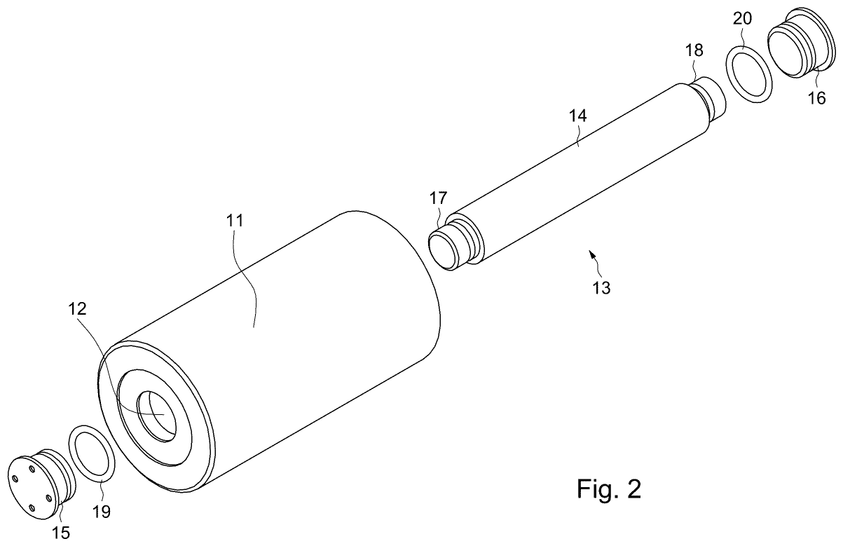

FIG. 2 illustrates schematically an example of a sensorized rolling element comprising a roller body 11 having a central bore 12 that extends through the roller body 11. A sensor unit 13 is mounted in the central bore 12. The sensor unit 13 comprises a housing 14 formed from two semi-cylindrical housing halves which are fixed together by means of first and second end caps 15, 16 that screw onto corresponding first and second threaded portions 17, 18 at opposite axial ends of the housing 14. The sensor unit housing 14 as a whole is shaped to fit within the central bore 12 of the roller body 11 and is mounted to and located in the bore 12 by means of first and second sealing elements 19, 20.

The sensor unit 13 further comprises sensors, a wireless transmitter to transmit sensor measuring parameters relating to the condition of the sensorized rolling element, a sampler to sample signals delivered by the sensors, and a battery supplying the sensors and the wireless transmitter.

The sampler records windows so that a limited amount of samples are collected. The number of samples is equal to a predetermined number of samples, for example equal to 100,000. The sensor unit 13 may for example comprise a load sensor for measuring a load distribution across the sensorized rolling element, an accelerometer for measuring the acceleration of the sensorized rolling element, and a gyroscope for determining a rotational speed Q of the sensorized rolling element in the rolling bearing 2.

The gyroscope is part of a first determining means for determining a rotation speed of the rotatable ring. In a variant, the rotation speed of the rotatable ring may be determined by using a speed sensor for measuring the rotation speed of the rotatable ring.

The processing module 3 (FIG. 12) comprises receiving means 21 connected to an antenna 22 of the processing module 3, second determining means 23, processing means 24, detecting means 25, and a processing unit 26 implementing the receiving means 21. The receiving means 21 receives through the antenna 22 a real time signal emitted by the wireless transmitter of the sensor unit 13 which is indicative of measurements of the sensors. The sensorized rolling element, the first determining means, and the processing module 3 form a system for monitoring the rolling bearing 2 in the machine 1.

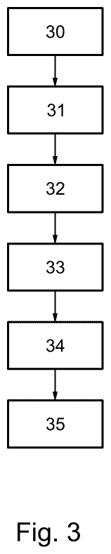

In the following, an example of a method for implementing the system is presented in FIG. 3.

In a step 30, the load sensor delivers a first signal to the sampler, and the accelerometer delivers a second signal to the sampler. The sampler samples the first and second signals to produce a first set of acceleration values and load values. Each value of the first set is associated to a sampling instant. The number of values is equal to the predetermined number of samples.

In a step 31, the wireless transmitter of the sensorized rolling element transmits the first set of acceleration values and load values. When the first set is transmitted, steps 30 and 31 may be repeated to generate and transmit other sets of acceleration values and load values, each set of acceleration values and load values having the predetermined number of samples.

In a step 32, the receiving device 21 receives the first set of acceleration values and load values, and in a step 33, the second determining means 23 determines a phase function P(t) of the sensorized rolling element according to the time t from the acceleration values of the first set and the rotation speed of the rotatable ring.

The rotation speed Q of the rotatable ring may be determined from values delivered by a gyroscope in the sensorized rolling element and wirelessly transmitted or from a sensor measuring the rotating speed of the rotatable ring.

The second determining means 23 convert the acceleration values of the first set associated with sampling instants to acceleration values of the first set associated with angular positions of the rotatable ring. The acceleration values measured in the time domain are converted to the angular domain of the rotatable ring.

The angular value θ(t) is equal to:

$$θ ( t ) = 360 Ω / ( 2 \cdot 60 ) t$$

where Ω is the rotation speed of the mobile ring in revolutions per minute and t is time.

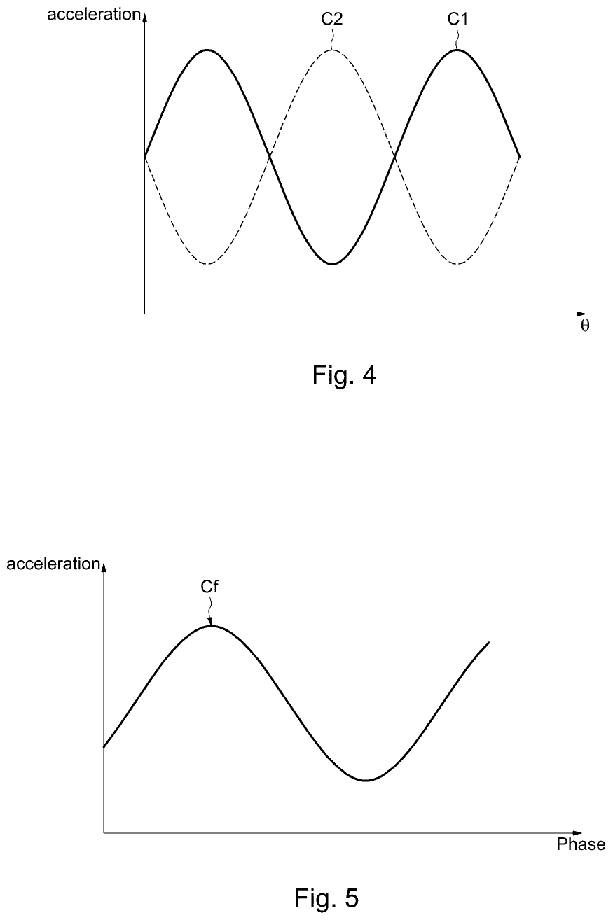

FIG. 4 illustrates schematically an example of a first curve C1 representing the acceleration values of the first set in the angular domain and a second curve C2 representing the acceleration values of a second set in the angular domain.

The second determining means 23 fit a sinusoidal function f(θ) on the acceleration values of the sets to link each acceleration value of the sets to an angular position of the mobile ring up to a tolerance value.

The sinusoidal function f(θ) is equal to:

$$f ( θ ) = sin ( 2 π ( F \cdot θ + Φ ) )$$

where F is the frequency of the curve C1, C2 and Φ is the phase shift.

To perform the sinusoidal fitting, a nonlinear regression algorithm may be implemented by the second determining means 2, the nonlinear regression algorithm minimizing least squares to estimate the parameters F and D that best fit the curves C1, C2.

FIG. 5 illustrates schematically an example of a curve Cf fitting the curves C1, C2 resulting from the nonlinear regression algorithm.

The phase function P(t) is determined by the second determining means 23 from the frequency F, the phase Φ, and the period T of the curves C1, C2.

The phase function P(t) is equal to:

$$P ( t ) = ( t - T 0 ) / T - [ ( t - T 0 ) / T ]$$

where [ ] is the floor function and TO is equal to:

$$T 0 = ( - Φ ) / F$$

In a step 34, the processing means 24 process the load values of the first set to determine the magnitude of a resulting signal representative of the frequency content of the envelope of the load values of the first set over time.

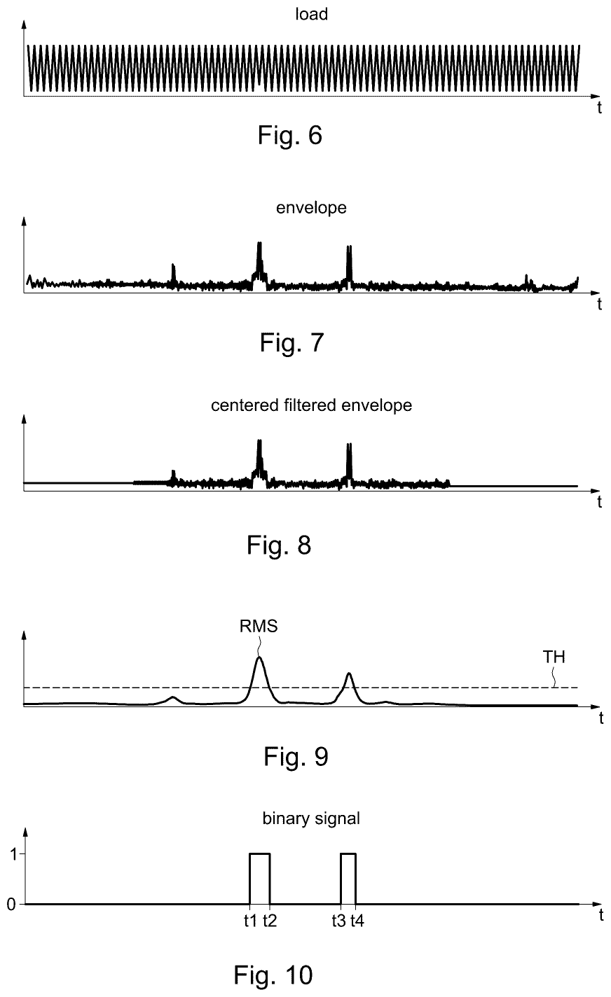

FIG. 6 illustrates schematically an example of load values of the first set over the time t. The processing means 24 filter the load values of the first set to remove the fundamental frequency of the load values. The processing means 24 may implement a notch filter designed to reject a narrow band of frequencies centered on the rotation frequency of the rotatable bearing. The rotation frequency may be determined by a Fast Fourier Transform of the acceleration values of the first set, the Fast Fourier Transform algorithm being implemented by the processing means 24.

The processing means determines an envelope signal of the filter load values by the notch filter and may implement a Hilbert transform of the filtered load values to obtain an analytical representation of the filtered load values. The envelop signal is the magnitude of the analytical representation. The envelop signal is upper and lower bounds of the load oscillations of the first set.

FIG. 7 illustrates schematically the envelope signal of the load values over the time t represented on FIG. 6.

The processing means 24 perform a first spectral analysis of the envelope to obtain the resulting signal. The first spectral analysis may comprise a continuous wavelet transform (CWT) of the envelope, and may use the Morlet wavelet transform. The CWT represents the frequency content of the envelope over time and decomposes the envelope signal into a series of wavelets which are oscillating functions that are characterized by both frequency and scale. The CWT allows for the analysis of envelope signals at different scales, which may be useful for identifying patterns that may not be apparent at a single scale.

The CWT is also well-suited for analyzing envelope signals with limited duration, as it may provide information about the frequency content of the signal at different points in time. All these characteristics make it perfect for analyzing the signals obtained by the sensorized roller element.

The processing means 24 may filter the envelope to reduce the sidelobes in the frequency domain before performing the CWT. The filtering of the envelope eases the analyze of the spectrum of the envelope performed.

FIG. 8 illustrates schematically an example of the filtered envelope signal identical to the resulting signal over the time t. The processing means 24 determine the root mean square of the resulting signal, the root mean square of the resulting signal being equal to the magnitude RMS of the resulting signal. The magnitude RMS of the resulting signal represents the energy of the resulting signal.

FIG. 9 illustrates schematically the magnitude RMS of the resulting signal over the time. In step 35, the detecting means 25 detect a damage of the rolling bearing and locate the damage on the bearing from the magnitude of the resulting signal and the phase function P(t).

A detection threshold TH is defined. The detection threshold may be determined based on nominal values of multiple recordings of the resulting signal. This may involve collecting a set of nominal values from a multitude of recordings of the resulting signal representing the expected or normal operating condition of the rolling bearing 2. The nominal values are then analyzed, for example, using a statistical algorithm, such as averaging or regression analysis, to determine the detection threshold TH. The detecting means 25 compare the magnitude RMS of the resulting signal to the predetermined detection threshold TH (FIG. 9).

When the magnitude RMS of the resulting signal is above the predetermined detection threshold TH a damage is detected. The detecting means 25 determine the location of the damage on the bearing from the instant and the duration of the magnitude of the resulting signal exceeding the detection threshold TH and the phase function P(t).

The magnitude RMS of the resulting signal and phase information determined from the phase function P(t) are compared against real time or subsequent recordings of set of acceleration values and load values and corresponding phase information of the rolling bearing 2. When the magnitude RMS of the resulting signal exceeds the detection threshold TH, the damage is detected and the location of the damage is determined based on the corresponding phase information.

FIG. 10 illustrates schematically an example of a binary signal resulting from the comparison over the time t. Between the instants t1 and t2, and the instants t3 and t4, the magnitude RMS of the resulting signal is above the detection threshold TH. A damage is detected between the instants t1 and t2, and the instants t3 and t4.

The determination of the phase function P(t) and the steps 30 to 35 are performed for each set of acceleration values and load values delivered by the sensorized roller element. When all of the set of acceleration values and load values are processed by the processing module 3, the detecting means 25 may create a graphical representation of the detected damages.

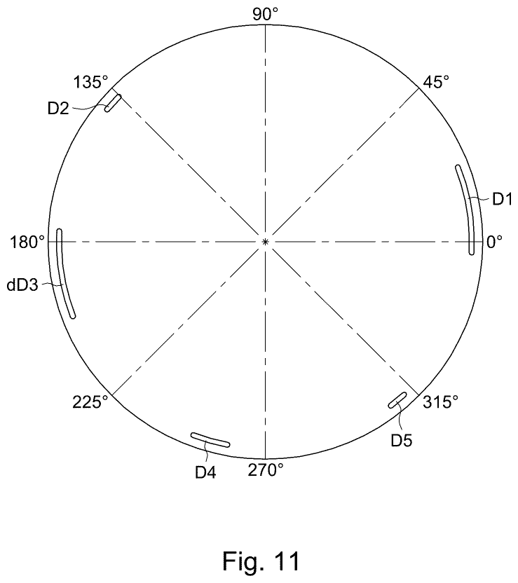

FIG. 11 illustrates schematically an example of a graphical representation of the detected damages. The rolling bearing 2 is represented as a circle CL. In this example, five damage locations D1, D2, D3, D4, D5 are detected. The damage locations D1, D2, D3, D4, D5 are identified by their angular position on the circle C1.

The presented method allows the data generated by sensors of the rolling bearing 2 from different recording sessions of the sensorized roller element to be aligned in order to detect and locate damages on the rolling bearing 2.

The first determining means, second determining means, receiving means, processing means, sampler and/or detecting means may comprise one or more programmable hardware components such as, but not limited to, a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor. Furthermore, a single programmable hardware component may perform include more than one of the first determining means, second determining means, receiving means, processing means, sampler and/or detecting means.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved roller bearing monitoring system and method.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for monitoring a rolling bearing in a machine,
the rolling bearing comprising a stationary ring having a first raceway and a rotatable ring having a second raceway mounted for concentric relative rotation, and
a plurality of rolling elements interposed the first raceway and the second raceway,
wherein at least one of the plurality of rolling elements is a sensorized rolling element including an accelerometer configured to measure an acceleration of the sensorized rolling element and output an acceleration signal indicative of the measured acceleration and a load sensor configured to measure a load on the sensorized rolling element and produce a load signal indicative of the measured load,
the method comprising:
sampling the acceleration signals and the load signals a predetermined number of times to produce a first set of acceleration values and a first set of load values, the acceleration values and load values each being associated with a sampling instant,
determining a rotation speed of the rotatable ring,
transmitting the first set of acceleration values and the first set of load values from the sensorized rolling element to a processor,
determining a phase function of the sensorized rolling element from the acceleration values and the rotation speed of the rotatable ring,
processing the load values of the first set of load values to determine a magnitude of a resulting signal representative of a frequency content of an envelope of the load values of the first set over time, and
detecting a damage of the rolling bearing and a location of the damage on the rolling bearing from the magnitude of the resulting signal and the phase function.

2. The method according to claim 1,
wherein the sensorized rolling element further comprises a gyroscope configured to produce an output, and including using the output of the gyroscope to determine the rotation speed of the rotatable ring.

3. The method according to claim 1,
wherein determining the phase function comprises:
determining an angular position of the rotatable ring at each of the instants from the acceleration values of the first set of acceleration values associated with the sampling instants,
fitting a sinusoidal function (Cf) to the acceleration values of the first set of acceleration values to link each acceleration value of the first set of acceleration values to an angular position of the rotatable ring up to a tolerance value, and
estimating a frequency and a phase shift of the sinusoidal function, the phase function P(t) being equal to:
$$P ( t ) = ( t - T 0 ) / T - [ ( t - T 0 ) / T ]$$
where F is the frequency, Φ is the phase, T0=−Φ/F, and T is a period of the acceleration samples of the first set.

4. The method according to claim 3, wherein processing the load values of the first set of load values comprises:
filtering the load values of the first set of load values to remove a fundamental frequency of the load values,
determining an envelope signal of the filtered load values, and
performing a first spectral analysis of the envelope signal of the filtered load values to obtain a resulting signal,
wherein a magnitude of the resulting signal is equal to a root mean square of the resulting signal.

5. The method according claim 4, wherein detecting a damage of the rolling bearing and locating the damage on the bearing comprises:
comparing the magnitude of the resulting signal to a predetermined detection threshold, and
when the magnitude of the resulting signal is above the predetermined detection threshold, determining a location of the damage on the bearing from the instant and the duration of the magnitude of the resulting signal exceeding the detection threshold and the phase function.

6. The method according to claim 4, further comprising filtering the envelope signal before performing the first spectral analysis of the envelope signal to reduce sidelobes in a frequency domain.

7. The method according to claim 6,
wherein determining the envelope of the filtered load values comprises performing a Hilbert transform of the filtered load values to obtain an analytical representation of the filtered load values, the envelope being the magnitude of the analytical representation.

8. The method according to claim 7, wherein performing a first spectral analysis comprises performing a continuous wavelet transform of the envelope signal.

9. The method according to claim 8, wherein the continuous wavelet transform is a Morlet wavelet transform.

10. The method according claim 1, wherein detecting a damage of the rolling bearing and locating the damage on the bearing comprises:
comparing the magnitude of the resulting signal to a predetermined detection threshold, and
when the magnitude of the resulting signal is above the predetermined detection threshold, determining a location of the damage on the bearing from the instant and the duration of the magnitude of the resulting signal exceeding the detection threshold and the phase function.

11. The method according to claim 1, wherein processing the load values of the first set of load values comprises:
filtering the load values of the first set of load values to remove a fundamental frequency of the load values,
determining an envelope signal of the filtered load values, and
performing a first spectral analysis of the envelope signal of the filtered load values to obtain a resulting signal,
wherein a magnitude of the resulting signal is equal to a root mean square of the resulting signal.

12. A monitoring system for monitoring a rolling bearing,
the rolling bearing comprising a stationary ring having a first raceway and a rotatable ring having a second configured for concentric rotation, and
a plurality of rolling elements interposed between the first raceway and the second raceway, at least one of the plurality of rolling elements being a sensorized rolling element having an accelerometer configured to measure an acceleration of the sensorized rolling element and a load sensor configured to measure a load on the sensorized rolling element, and a sampler configured to sample signals output by the accelerometer and the load sensor, and wherein the system comprises:
first determining means configured to determine a rotation speed of the rotatable ring,
receiving means configured to receive at least a first set of acceleration values and load values from the sampler, each value of the first set being associated with a sampling instant, the number of values being predetermined,
second determining means configured to determine a phase function of the sensorized rolling element from the acceleration values and the rotation speed of the rotatable ring,
processing means configured to process the load values of the first set to determine the magnitude of a resulting signal representative of the frequency content of the envelope signal of the load values of the first set over time, and
detecting means configured to detect a damage of the rolling bearing and locating the damage on the bearing from the magnitude of the resulting signal and the phase function.
